(19) United States
(12) Patent Application Publication
(10) Pub. No.: US 2024/0387096 A1
(43) Pub. Date: Nov. 21, 2024

(54) RESONANT TRANSFORMERS WITH CALIBRATABLE FLUX-SHUNT

(71) Applicant: Enphase Energy, Inc., Petaluma, CA (US)

(72) Inventors: Michael J. HARRISON, Petaluma, CA (US); Tyrone David LOW, Christchurch (NZ)

(21) Appl. No.: 18/634,292

(22) Filed: Apr. 12, 2024

Related U.S. Application Data
(60) Provisional application No. 63/467,219, filed on May 17, 2023.

(51) Int. Cl. H01F 27/28; H01F 30/10; H01F 38/08; H01F 38/42; H01F 41/10

(52) U.S. Cl. CPC H01F 27/2828; H01F 30/10; H01F 38/42; H01F 41/10; H01F 38/08

(57) ABSTRACT

The present disclosure provides a transformer configured for use with a power converter of an energy management system. For example, the transformer comprises an adjustable flux-shunt configured to be positioned onto an inner round limb of a core half and rotated around the inner round limb to obtain an adequate leakage inductance corresponding to a set position of the adjustable flux-shunt.

### CROSS-REFERENCE TO RELATED APPLICATIONS

The present application claims the benefit of and priority to U.S. Provisional Application Ser. No. 63/467,219, filed on May 17, 2023, the entire contents of which is incorporated herein by reference.

### BACKGROUND

### Field of the Disclosure

Embodiments of the present disclosure relate generally to microinverters configured for use with energy management systems and, for example, to microinverters comprising resonant transformers with calibratable flux-shunt.

### Description of the Related Art

Microinverters configured for use with energy management systems are known. For example, conventional microinverters can comprise one or more types of transformers. For example, some microinverters can comprise a concentric pot core (CPC) resonant transformer, which resembles an industry standard pot core (PH) transformer but can double as a resonant inductor to enable very efficient resonant power conversion. The specific detail that differentiates the CPC design from the conventional PH design is based on placing a flux-shunt between the primary and secondary windings of the transformer to physically separate the primary and second winding and electrically add a controlled high leakage inductance coupling the separated primary and secondary windings.

The CPC can feature three (3) limbs on each core half, e.g., a center limb, an intermediate limb, and an outer limb. Conversely, conventional PH cores do not feature the additional intermediate limb. The intermediate limb can be used to implement the flux-shunt, which is achieved by introducing a precise gap between the mating faces between the pair of the CPC core halves for the intermediate limb only. The center and outer limbs of the two core halves have no gap between the mating surfaces. To manufacture the CPC transformer with a precise gap for the intermediate limb (which forms the flux-shunt) requires a very specialized grinding process, as the gapped surface on intermediate limb is lower than the center and outer limbs. Additionally, the gap needs to be grinded with a high grinding precision to accurately control and repeat primary to secondary leakage inductance. Moreover, the cost associated with gapping the intermediate limb for the flux-shunt makes the CPC resonant transformer expensive to manufacture.

Similarly, the industry standard PQ based resonant transformer core design has a range of ferrite cores that can be manufactured in very high volume and can use a relatively simple single pass grinding process for the core mating surfaces. For example, the PQ based resonant transformer is based on custom primary and secondary plastic bobbins that keep the primary and secondary windings separated, and the plastic bobbins feature finger details that are used to locate a custom ferrite flux-shunt that separates the primary and secondary windings, while providing a high leakage inductance coupling the primary and secondary windings electrically. The PQ based resonant transformer, with the correct gapping applied to the flux-shunt, has good electrical performance. A fundamental problem with the PQ based resonant transformer, however, relates to manufacturing tolerances of the ferrite PQ core halves and the ferrite flux-shunt. For example, the ferrite core components can shrink by up to about 15% during the manufacturing process, which can result in the finished core dimensions having a tolerance of ±2%.

As noted above, the dimensions of the flux-shunt in the CPC resonant transformer can be controlled in manufacture based on the precision grinding process used to gap the intermediate limb of the core. Conversely, the dimension of the flux-shunt in the PQ resonant transformer is a function of the tolerance stack up between the ±2% tolerance for the PQ core and the ±2% tolerance for the ferrite flux-shunt. Additionally, a further tolerance compounding effect can also be introduced into the manufacturing of the PQ resonant transformer because of the flux-shunt gap being the result of a small dimensional difference between two larger dimensions (e.g., core and shunt). For example, in the PQ resonant transformer, the flux-shunt gap represents about 20% of the radial space between the opposed faces of the center and outer limbs of the PQ core. Thus, the 20% ratio creates about a 5× compounding impact on the tolerance stack up for the flux-shunt tolerance resulting in a total dimensional tolerance of ±20% for the PQ resonant transformer flux-shunt gap. Accordingly, the mechanical tolerance effectively translates to approximate ±20% tolerance in the leakage inductance for the PQ resonant transformer design, compared to the CPC leakage inductance tolerance of about ±5%.

Accordingly, there is a need for improved microinverters comprising resonant transformers with calibratable flux-shunt.

### SUMMARY

In accordance with some aspects of the disclosure, a transformer configured for use with a power converter of an energy management system comprises an adjustable flux-shunt configured to be positioned onto an inner round limb of a core half and rotated around the inner round limb to obtain an adequate leakage inductance corresponding to a set position of the adjustable flux-shunt.

In accordance with some aspects of the disclosure, an energy management system comprises a power source; a controller; and a power converter comprising a transformer comprising an adjustable flux-shunt configured to be positioned onto an inner round limb of a core half and rotated around the inner round limb to obtain an adequate leakage inductance corresponding to a set position of the adjustable flux-shunt.

In accordance with some aspects of the disclosure, a method of manufacturing a transformer comprises positioning an adjustable flux-shunt over an inner round limb of a transformer core half; adjusting the adjustable flux-shunt while directly measuring a transformer leakage inductance; and applying one or more suitable adhesives into a gap between the adjustable flux-shunt and the transformer core half to lock the adjustable flux-shunt in place and prevent further calibration adjustment.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is an exploded view of a transformer configured for use with a microinverter of an energy management system, in accordance with one or more embodiments of the present disclosure;

FIG. 2 is diagram of an adjustable flux-shunt of the transformer of FIG. 1 shown in three configurations, in accordance with one or more embodiments of the present disclosure;

FIG. 3 is a diagram of core half configurations of the transformer of FIG. 1, in accordance with one or more embodiments of the present disclosure;

FIG. 4 is a diagram of a conventional transformer core half compared to a core half of the transformer of FIG. 1, in accordance with one or more embodiments of the present disclosure;

FIG. 5 is a block diagram of a system for power conversion using the transformer of FIG. 1, in accordance with one or more embodiments of the present disclosure; and

FIG. 6 is a flowchart of a method of manufacturing a transformer, in accordance with one or more embodiments of the present disclosure.

### DETAILED DESCRIPTION

As noted above, there is a need for improved microinverters comprising resonant transformers with calibratable flux-shunt. For example, a transformer configured for use with a power converter of an energy management system can comprise an adjustable flux-shunt configured to be positioned onto an inner round limb of a core half and rotated around the inner round limb to obtain an adequate leakage inductance corresponding to a set position of the adjustable flux-shunt. Accordingly, the transformers described herein provide an alternative resonant transformer configuration that is practical and low cost to manufacture (e.g., partially due to an innovative, novel calibratable flux-shunt design and partially due to being based on a simpler geometry design than the CPC, which can decrease an overall manufacturing cost of the microinverters in which the transformers are used.

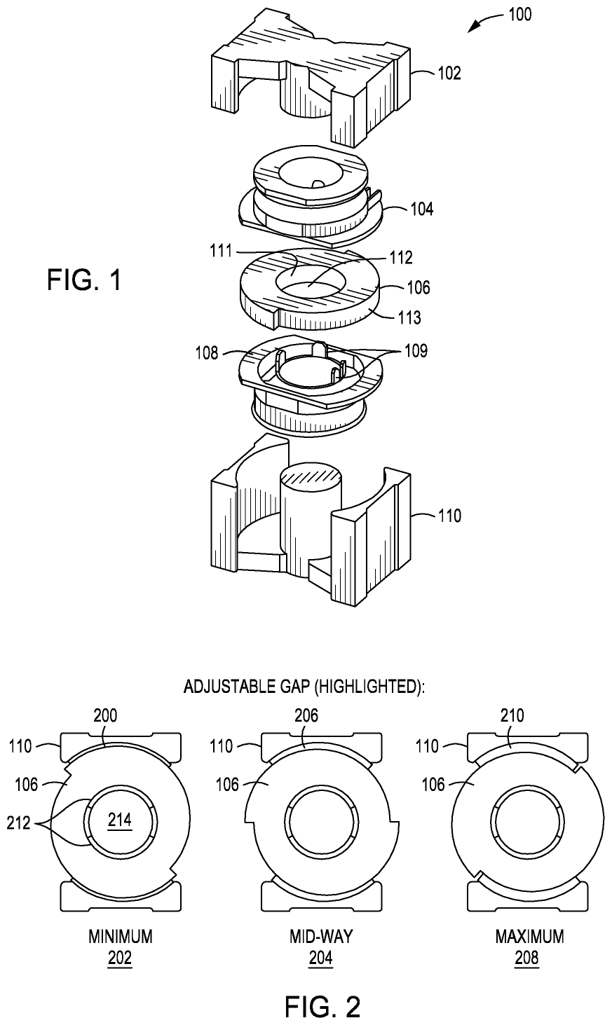

FIG. 1 is an exploded view of a transformer 100 configured for use with a microinverter of an energy management system, in accordance with one or more embodiments of the present disclosure. The transformer 100 of the present disclosure overcomes the fundamental issue related to the tolerance of the ferrite core and flux-shunt associated with the PQ resonant transformers using three specific changes. For example, the bobbins are designed to support the inner radius of the flux-shunt and allow its rotation to facilitate calibration. Additionally, the flux-shunt design is changed to include a double spiral detail. Moreover, the PQ core half has been reconfigured to work with the spiral detail on the adjustable flux-shunt. Thus, the flux-shunt design can be used with a modified/reconfigured transformer core. Alternatively, the flux-shunt design can be used with existing transformer cores. The three specific changes are used so that the transformer can be calibrated during a manufacturing process of the transformer 100, as described in greater detail below.

Continuing with reference to FIG. 1, the transformer 100 comprises a core half 102, a winding (e.g., a primary winding) on a bobbin 104, an adjustable flux-shunt 106, a winding (e.g., a secondary winding) on a bobbin 108, and a core half 110 (e.g., a modified PQ core half). The core half 102, the bobbin 104, and the bobbin 108 are configured and operate in a conventional manner, so a detailed description of the core half 102, the bobbin 104, and the bobbin 108 is omitted for brevity.

The adjustable flux-shunt 106 can have a flux-shunt adjustment range of about ±45° (e.g., 90° total adjustment) to match the 90° winding aperture in the core half 102 and the core half 110, which together make up the transformer 100 core. The inventive concepts described herein, however, can be used with one or more other transformer core configurations including, but not limited to, PM transformer cores, RM transformer cores, EQ transformer cores, ETD transformer cores, etc. Thus, the total adjustment range will be equal to the core winding aperture (measured in radial degrees) for the PM transformer cores, RM transformer cores, EQ transformer cores, and ETD transformer cores.

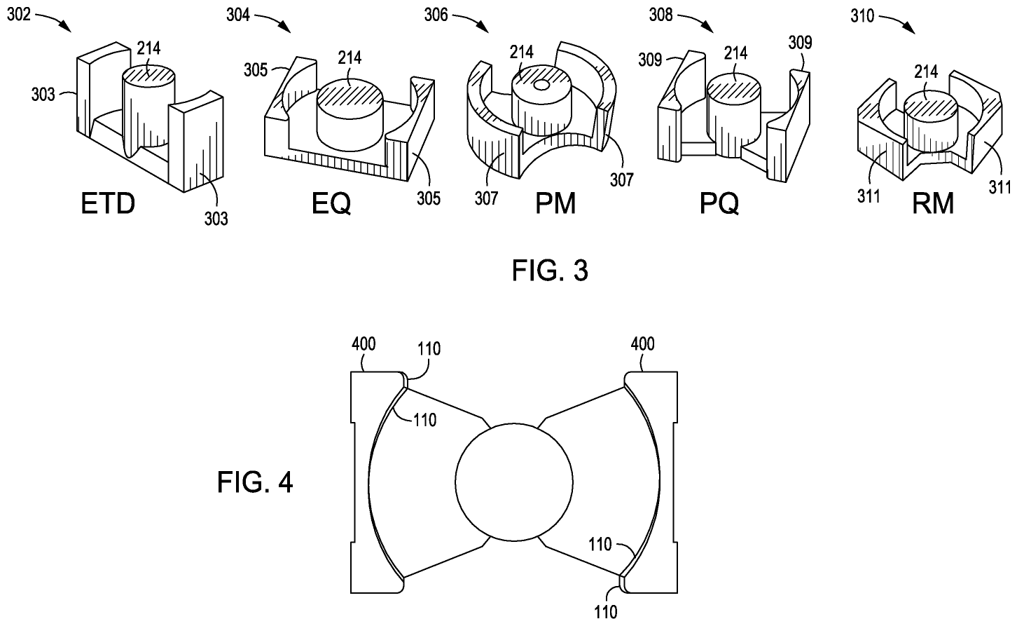

In at least some embodiments, the adjustable flux-shunt 106 can be in the form of a flat ferrite plate with an optimum design thickness equal to about half a radius of an inner round hole 112 defined through the adjustable flux-shunt 106 and by an inner gap face 111. The adjustable flux-shunt 106 comprises an outer double spiral shape defined by an outer gap face 113. In at least some embodiments, the outer double spiral shape can be based on a radius that increases linearly with an angular rotation of the adjustable flux-shunt 106. For example, an amount of the radial increase of the double spiral shape can be configured to meet an objective total flux gap adjustment range. For example, in at least some embodiments, the total flux gap adjustment range can be about a 2 mm increase over 180° of rotation (see 200, 206, and 210 of FIG. 3 for example). For example, the full adjustment range (e.g., 90°) can be configured to meet an objective total gap adjustment range (e.g., 2 mm) resulting in a gap calibration range of about ±1 mm for about a ±45° of rotation of the adjustable flux-shunt 106. In at least some embodiments, the objective total gap adjustment can be determined by considering a total stack up of all the various tolerances (e.g., mechanical and electrical) for a final resonant transformer design to ensure that there is sufficient calibration range to compensate for the entire stack up of all manufacturing tolerances. The inventors note that excessive adjustment range can sometimes reduce the calibration adjustment resolution, therefore making the exact calibration that is desired obtainable, but a bit more challenging to achieve.

FIG. 2 is diagram of the adjustable flux-shunt 106 of the transformer 100 of FIG. 1 shown in three configurations, in accordance with one or more embodiments of the present disclosure. For example, a minimum adjustable outer gap 200 can be designed around an expected manufacturing tolerance of the core half 110 such that the outer gap will always be >0 in a minimum adjusted position 202. For example, the total gap can equal a sum of the adjustable outer gap plus the inner fixed gap. The nominal desired gap can be designed by calculating the required inner hole diameter for the adjustable flux-shunt 106 so that the nominal desired gap can be achieved with the calibration adjustment set at the mid-point of the adjustment (see a mid-way adjusted position 204 having a mid-way adjustable outer gap 206), and a maximum adjusted position 208 can have an adjustable outer gap 210.

A mechanical deformable spacer 212 (e.g., non-conductive material, such as plastic, ceramic, etc.) can be used to keep the adjustable flux-shunt 106 centered around an inner round limb 214 of the core half 110 (see the minimum adjusted position 202). In at least some embodiments, the mechanical deformable spacer 212 can be an inner finger 109 that is an integral part of the winding (e.g., a primary winding) on the bobbin 104 and the winding (e.g., a secondary winding) on the bobbin 108 (see FIG. 1, for example).

FIG. 3 is a diagram of core half configurations of the transformer 100 of FIG. 1, in accordance with one or more embodiments of the present disclosure. As noted above, the inventive concepts described herein can be used with most, if not all, conventional resonant transformers. For example, a magnetic core of a conventional transformer (e.g., ETD transformers 302, EQ transformers 304, PM transformers 306, PQ transformers 308 (e.g., the transformer 100), and RM transformers 310) requires a round center limb (e.g., the inner round limb 214) as well as a concentric inner profile on the outer two limbs (e.g., 303, 305, 307, 309, and 311). Accordingly, in at least some embodiments, the inventive concepts described herein modifies/improves on the standard core shapes such that the concentric inner profile on the outer two limbs has a spiral shape to match that used on the adjustable flux-shunt 106 (e.g., 1 mm radius increase over 90° of rotation). For example, a core half mating surface of the modified/improved core configurations is relatively close enough in the shape to the industry standard core designs that when mated with a standard core any mismatch in the outer limb shapes will be minimal and similar to the typical mismatch that results from the normal core to core manufacturing variability (e.g., due to tolerance).

Accordingly, in at least some embodiments, the adjustable flux-shunt 106 can be configured to sit over the core half 110 resulting in a core split line being off center compared to a complete transformer assembly. For example, a typical transformer configuration that uses equally sized primary and secondary bobbins can be made using a modified core half (e.g., the core half 110/the core half 110, 40/50) that features core limbs that are longer than the matching industry standard core half (e.g., 40/30). Thus, combining the two core halves that feature unequal core limb lengths will result in the core split line being off center. For example, the combination of a transformer with a 40/50 ratio with a transformer with a 40/30 ratio will give a transformer with a total core height that would be obtained by using a transformer with a pair of cores having a 40/40 ratio (e.g., 40 mm). Thus, in at least some embodiments, a difference in the core half lengths used are greater than the thickness of the adjustable flux-shunt 106 to ensure that the adjustable flux-shunt 106 is not covering the core split line.

Alternatively, in at least some embodiments, the adjustable flux-shunt 106 can be configured for use with a pair of industry standard core halves (e.g., PQ transformer). In such embodiments, an outer radial adjustable gap between the outer spiral of the adjustable flux-shunt 106 and an inner concentric faces of the outer limbs of the core half 110 will not be parallel, resulting in a tapered outer gap, which is not desirable as the tapered outer gap can sometimes provide a leakage inductance (which varies according to the inverse of the operating current) for the resonant transformer. If, however, a total gap adjustment can be made small enough (e.g., 0.5 mm), then it is highly unlikely that the difference in the modified core dimensions to the industry standard core shape will have any adverse effect (e.g., due to manufacturing tolerances). Accordingly, in at least some embodiments, symmetrical core halves can be used and the adjustable flux-shunt 106 can be centered over the core split line, i.e., a less than optimum design that uses industry standard (unmodified) core halves can work as well as the theoretical optimum design, thus reducing the need to manufacture a special core for the industry standard core halves.

FIG. 4 is a diagram of a standard transformer half core 400 compared to a core half (the core half 110) of the transformer of FIG. 1, in accordance with one or more embodiments of the present disclosure. For example, FIG. 4 shows the difference between an industry standard transformer half core 400 (e.g., a PQ core half (in orange)) and the core half 110 (in black). As evidenced by FIG. 4, such a small difference between the industry standard transformer half core 400 and the core half 110 allows the adjustable flux-shunt 106 to be used directly with the industry standard transformer half core 400, rather than requiring a custom core half (e.g., the core half 110), which may result in a small (insignificant) reduction in performance but would still provide a more cost effective solution compared to conventional transformers.

In at least some embodiments, a manufacturing process (e.g., a method 600) of the transformer 100 can comprise positioning the adjustable flux-shunt 106 over an inner round limb of a transformer core half (see 602 of FIG. 6). For example, the adjustable flux-shunt 106 can be positioned over the inner round limb 214 of the core half 110. Next, the method can comprise adjusting (rotating) the adjustable flux-shunt 106 while directly measuring the transformer leakage inductance (e.g., using an inductance meter), see 604 of FIG. 6. For example, in at least some embodiments, the adjustable flux-shunt 106 can be rotated from the minimum adjusted position 202 to the mid-way adjusted position 204 and from the mid-way adjusted position 204 to the maximum adjusted position 208. Next, once the desired leakage inductance has been determined/set, the method can comprise applying one or more suitable adhesives into the gap between the adjustable flux-shunt 106 and the core half 110 to lock the adjustable flux-shunt 106 in place and prevent further calibration adjustment (see 606 of FIG. 6). Once the transformer is fully assembled, the transformer can be used with one or more microinverters.

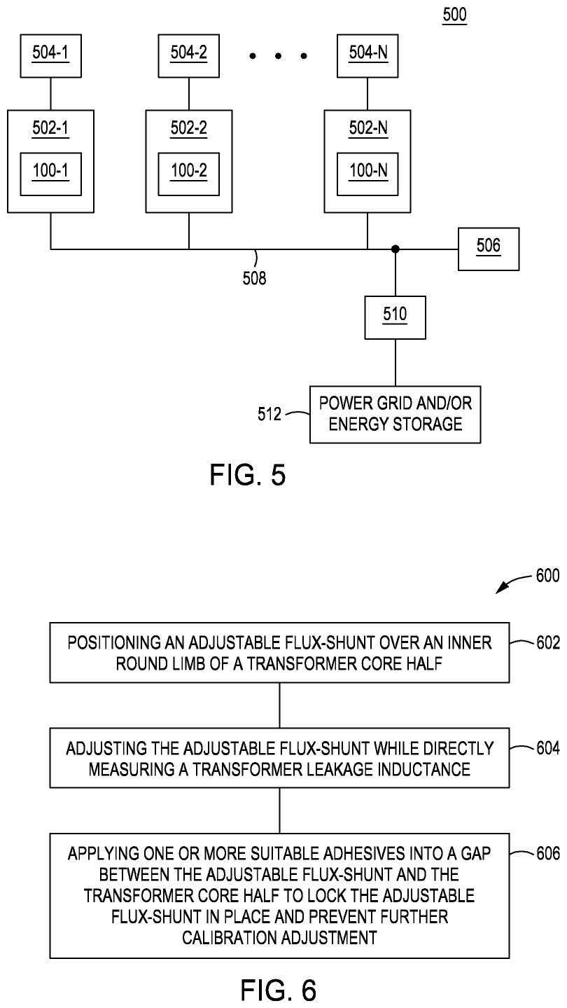

For example, FIG. 5 is a block diagram of a system 500 for power conversion (e.g., an energy management system) using the transformer of FIG. 1, in accordance with one or more embodiments of the present disclosure.

For example, the system 500 comprises a plurality of power converters 502-1, 502-2 . . . 502-N, collectively referred to as power converters 502 (e.g., power conditioners); a plurality of power sources 504-1, 504-2 . . . 504-N, collectively referred to as power sources 504; a controller 506; a bus 508; and a load center 510. The power sources 504 may be any suitable DC source, such as an output from a previous power conversion stage, a battery, a renewable energy source (e.g., a solar panel or photovoltaic (PV) module, a wind turbine, a hydroelectric system, or similar renewable energy source), or the like, for providing DC power. In some embodiments, the power converters 502 may be bidirectional converters and one or more of the power sources 504 is an energy storage/delivery device that stores energy generated by the power converter 502 and couples stored energy to the power converter 502.

Each power converter 502-1, 502-2 . . . 502-N is coupled to a power source 504-1, 504-2 . . . 504-N, respectively, in a one-to-one correspondence; in some alternative embodiments, multiple power sources 504 may be coupled to a power converter 502. The power converters 502-1, 502-2 . . . 502-N may be AC-AC converters that receive AC input and convert one type of AC power to another type of AC power. In other alternative embodiments, the power converters 502-1, 502-2 . . . 502-N may be DC-DC converters that convert one type of DC power to another type of DC power. In some of embodiments, the DC-DC converters may be coupled to a main DC-AC inverter for inverting the generated DC output to an AC output. The power converters 502 are coupled to the controller 506 via the bus 508.

The controller 506 is capable of communicating with the power converters 502 by wireless and/or wired communication (e.g., power line communication) for providing operative control of the power converters 502. In some embodiments, the controller 506 may be a gateway that receives data (e.g., performance data) from the power converters 502 and communicates the data and/or other information to a remote device or system, such as a master controller (not shown). Additionally or alternatively, the gateway may receive information from a remote device or system (not shown) and may communicate the information to the power converters 502 and/or use the information to generate control commands that are issued to the power converters 502. The power converters 502 are further coupled to the load center 510 via the bus 508.

The power converters 502 convert the DC power from the DC power sources to an AC output power and couple the generated output power to the load center 510 via the bus 508. The generated power may then be distributed for use, for example to one or more appliances, and/or the generated energy may be stored for later use, for example using batteries, heated water, hydro pumping, H₂O-to-hydrogen conversion, or the like. In some embodiments, the power converters 502 convert the DC input power to AC power that is commercial power grid compliant and couple the AC power to the commercial power grid via the load center 510. In some other embodiments, the power converters 502 may be AC: AC converters that receive an AC input; in still other embodiments, the power converters 502 may be AC: DC or DC: DC converters and the output power is a DC output power and the bus 508 is a DC bus.

In at least some embodiments, the load center 510 can connect to a storage system 512 configured for use with the system 500, such as the ENSEMBLE® energy management system available from ENPHASE®. For example, the storage system 512 can comprise an AC battery system. Alternatively, the storage system 512 can be a DC battery system with a corresponding battery and DC/DC power converters.

Each of the power converters 502 comprises a transformer (i.e., the power converters 502-1, 502-2 . . . 502-N comprise transformer assemblies 100-1, 100-2 . . . 100-N, respectively, which include the adjustable flux-shunt 106) utilized in the conversion of the input power to the output power. In some embodiments, the power converters 502 are flyback converters. In other embodiments, the power converters 502 are resonant converters and the transformer 150 may comprise a corresponding flux shunt (not shown).

While the foregoing is directed to embodiments of the present disclosure, other and further embodiments of the disclosure may be devised without departing from the basic scope thereof, and the scope thereof is determined by the claims that follow.

What is claimed is:

1. A transformer configured for use with a power converter of an energy management system, comprising:
an adjustable flux-shunt configured to be positioned onto an inner round limb of a core half and rotated around the inner round limb to obtain an adequate leakage inductance corresponding to a set position of the adjustable flux-shunt.

2. The transformer of claim 1, further comprising a mechanical deformable spacer that is positioned between an inner gap face of the adjustable flux-shunt and the inner round limb.

3. The transformer of claim 2, wherein the mechanical deformable spacer is an inner finger that is an integral part of a winding on a bobbin connected to the core half.

4. The transformer of claim 1, wherein the adjustable flux-shunt has a flux-shunt adjustment range of about ±45°.

5. The transformer of claim 1, wherein the adjustable flux-shunt is a flat ferrite plate having an outer double spiral shape defined by an outer gap face.

6. The transformer of claim 5, wherein the outer double spiral shape is based on a radius that increases linearly with an angular rotation of the adjustable flux-shunt to meet a total flux gap adjustment range.

7. The transformer of claim 6, wherein the total flux gap adjustment range is about a 2 mm increase over 180° of rotation of the adjustable flux-shunt.

8. The transformer of claim 5, wherein the flat ferrite plate has a thickness equal to about half a radius of an inner round hole defined through the adjustable flux-shunt and by an inner gap.

9. An energy management system, comprising:
a power source;
a controller; and
a power converter comprising a transformer comprising an adjustable flux-shunt configured to be positioned onto an inner round limb of a core half and rotated around the inner round limb to obtain an adequate leakage inductance corresponding to a set position of the adjustable flux-shunt.

10. The energy management system of claim 9, further comprising a mechanical deformable spacer that is positioned between an inner gap face of the adjustable flux-shunt and the inner round limb.

11. The energy management system of claim 10, wherein the mechanical deformable spacer is an inner finger that is an integral part of a winding on a bobbin connected to the core half.

12. The energy management system of claim 9, wherein the adjustable flux-shunt has a flux-shunt adjustment range of about ±45°.

13. The energy management system of claim 9, wherein the adjustable flux-shunt is a flat ferrite plate having an outer double spiral shape defined by an outer gap face.

14. The energy management system of claim 13, wherein the outer double spiral shape is based on a radius that increases linearly with an angular rotation of the adjustable flux-shunt to meet a total flux gap adjustment range.

15. The energy management system of claim 14, wherein the total flux gap adjustment range is about a 2 mm increase over 180° of rotation of the adjustable flux-shunt.

16. The energy management system of claim 13, wherein the flat ferrite plate has a thickness equal to about half a radius of an inner round hole defined through the adjustable flux-shunt and by an inner gap.

17. A method of manufacturing a transformer, comprising:
positioning an adjustable flux-shunt over an inner round limb of a transformer core half;
adjusting the adjustable flux-shunt while directly measuring a transformer leakage inductance; and
applying one or more suitable adhesives into a gap between the adjustable flux-shunt and the transformer core half to lock the adjustable flux-shunt in place and prevent further calibration adjustment.
